(19) United States
(12) Patent Application Publication
(10) Pub. No.: US 2010/0136190 A1
(43) Pub. Date: Jun. 3, 2010

(54) METHOD FOR THE SELECTIVE EXTRACTION AND SEPARATION OF ORGANIC SUBSTANCES BY MEANS OF HIGH PRESSURE

(76) Inventors: Michael Bork, Dortmund (DE); Christoph Luetge, Unna (DE)

Correspondence Address: MARSHALL & MELHORN, LLC, FOUR SEAGATE - EIGHTH FLOOR, TOLEDO, OH, 43604, US

(21) Appl. No.: 12/312,697

(22) PCT Filed: Nov. 21, 2007
(86) PCT No.: PCT/EP2007/010065

§ 371 Date: Jan. 19, 2010

(30) Foreign Application Priority Data
Nov. 23, 2006 (DE) 10 2006 055 710.7

(51) Int. Cl. C11B 1/10

(52) U.S. Cl. 426/417

(57) ABSTRACT

The invention relates to an extraction method for producing soluble substances from organic plant or animal raw material with high pressure, wherein supercritical gas is used as a solvent and wherein the organic material is filled into one or a plurality of high pressure reservoirs. The high pressure reservoirs are closed and a pressure of more than 800 bar is subsequently applied. In an extraction step, the supercritical gas flows at least once through the filled high pressure reservoir, wherein no additional entraining agent is added to the supercritical gas. Subsequently the charged supercritical gas is fed completely or partially to a separation stage, wherein natural substances or substance mixtures are reacted or separated from each other by lowering the pressure. The pressure in the extraction stage exceeds the maximum solubility pressure of the oil or fat of the raw material in the supercritical gas at least by 10%. The respective oil or fat of the raw material serves as the entraining agent.

The invention relates to a process for the recovery of soluble constituents from organic raw materials at pressures above 1100 bar up to 5000 bar by means of a supercritical gas, in which the addition of entrainers is dispensed with completely.

Processes for the extraction of plant and animal raw materials are known and are usually operated by means of supercritical CO₂ as a solvent. Such processes make use of the circumstance that supercritical gas reacts almost analogously to a liquid and that excellent solubility of essential materials in supercritical CO₂ is ensured. Well-known is the decaffeination of coffee.

It is further known that the solubility of materials rises if, for example, temperature and pressure are increased. It is further known that maximum solubility is reached with constant temperature and increasing pressure. At a pressure increase beyond the maximum the solubility will diminish.

WO 2006/05537 A1 describes an extraction process by means of CO₂ for separating caffeine from a tea plant. For this purpose, pressures of up to 1000 bar and temperatures of up to 80° C. are recommended as processing parameters.

EP 1 424 385 B1 describes a further process for the production of a xanthohumol-enriched hop extract and its application. This process takes place at a maximum pressure of up to 1000 bar and temperatures above 60° C. The two afore-mentioned processes specify 1000 bar as a limit for the pressure in the extraction stage at similar temperatures. The ideal range of the extraction is given to be somewhat below 1000 bar. This limit of 1000 bar described in WO 2006/05537 A1 and EP 1 424 385 B1 is identical to the physically determined range in which the maximum solubility of the raw-material-specific natural oils in the supercritical gas CO₂is reached, the exact pressure being dependent on the respective temperature.

These pressures are to be considered as very high even for industrial applications, as pressures applied in the extraction process usually range between 300 bar and 500 bar. DE 1 95 24 481 C2, DE 44 00 096 C2 or DE 198 54 807 A1 describe such processes.

According to the state of the art, the solubility is generally not increased by further raising the pressure but by using so-called entrainers. Entrainers such as ethanol, acetone, hexane or water change the polarity of the solvent and thus also the solvent properties. A disadvantage involved is that the added entrainer is to be separated again. This increases the cost of the extraction process, in which a 100% separation is frequently impossible, which leads to undesired impurities. DE 198 54 807 A1 recommends to add ethanol or hexane as a co-solvent or entrainer in the extraction of dried egg-yolk lecithin.

Known are also processes which do not require any additional entrainers. U.S. Pat. No. 4,466,923, for example, describes a process in which a lipid is extracted from a material containing lipids by means of supercritical carbon dioxide, where the extraction is carried out at a pressure ranging between 550° C. and 1200° C. and a solubility of at least 5% of the supercritical carbon dioxide in the material to be extracted is set by selecting pressure and temperature. Substance mixtures to be extracted, however, involve the problem that the different components have different dissolving behaviours and that, as pressure and temperature are increasing, the solubility of some components will still be rising while the solubility of other components, in most cases the more readily soluble ones, will already be decreasing again.

This proves that there is a persistent demand for a high-purity extraction of poorly soluble constituents from plant or animal raw materials.

This task is resolved with the extraction process according to the present invention for the recovery of soluble substances from plant or animal organic raw materials under high pressure, in which at least one supercritical gas is used as a solvent, in which
one or more high-pressure vessels are filled with the organic material, sealed and then submitted to a pressure of more than 800 bar, subsequently
the supercritical gas is passed at least once through the filled high-pressure vessel in an extraction stage, without admixing any additional entrainer to the supercritical gas and subsequently
the laden supercritical gas is completely or partly supplied to a separating stage in which natural substances or mixtures of substances are separated or separated of each other while decreasing the pressure, and
the pressure in the extraction stage exceeds the maximum solubility pressure of the raw-material-specific oil or fat in the supercritical gas by at least 10%, the respective raw-material-specific oil or fat acting as an entrainer.

It is of decisive importance in this connection that the pressure in the extraction stage exceeds the maximum solubility pressure of the raw-material-specific oil or fat in the supercritical gas by at least 10%, this pressure increase may also be significantly above the maximum solubility pressure of the raw-material-specific oil or fat. When using carbon dioxide (CO₂) as the supercritical gas, the pressure should preferably range between 1100 bar and 5000 bar, in the ideal case, between 1300 bar and 2500 bar.

A surprising finding was that when excessively increasing the pressure in the extraction stage the raw-material-specific oils and fats have the effect of a raw-material-specific or species-specific entrainer for the substance or substance mixture to be recovered. In this way, it is also possible to extract substances from mixtures of substances without admixing entrainers that previously could not have been recovered at all by supercritical extraction or only by adding organic entrainers.

An embodiment of the invention provides for the supercritical gas being re-circulated several times through the organic material in the high-pressure vessel of the extraction stage. A further embodiment of the invention provides for a change in the temperature of the supercritical gas before or in the separation stage by means of a heat exchanger.

The extraction process can be improved in such a way that the pressure in the first separator which follows the extraction stage downstream is adjusted within the range of the maximum solubility of the raw-material-specific oil or fat in CO₂ and is maximally 2% above or below that solubility maximum in the ideal case. Here too, a surprising observation was made. At such pressure level, the obtained fraction of hardly extractable substances remains in the gaseous mixture of solvent and oil and can thus be separated relatively easily from the mixture of more readily soluble substances. The separation of these hardly soluble substances is then carried out in subsequent separators. The pressure in the first separator preferably ranges between 800 bar and 1000 bar.

An improved embodiment of the process provides for the extraction being carried out in two stages. Before the extraction at the aforementioned pressures above 1100 bar, an upstream extraction stage is provided, involving a pressure which is within the range of the maximum solubility of the raw-material-specific oil or fat in CO₂ and is maximally 2% above or below that maximum in the ideal case, i.e. as in the first separator after the complete extraction. A large part of the substances to be extracted can be separated through this preliminary extraction in the first stage, thus preventing them from being re-precipitated from the solution if the pressure is subsequently raised once again significantly, to then extract the hardly extractable constituents in a second extraction stage, at pressures that exceed the maximum solubility pressure of the raw-material-specific oil or fat in the supercritical gas by at least 10%, the respective raw-material-specific oil or fat serving as entrainer. Since part of the raw-material-specific oil or fat shall serve as entrainer, it may of course not be completely separated during the first extraction stage but only in as far as not to affect the ‘entrainer effect’ for the subsequent extraction.

In an improved embodiment of the process, at least two and, in the ideal case, three or four separators are provided in the separation stage, which are of different pressure levels. By this graduation it is possible to achieve a preliminary separation of the extracted mixture of substances.

In several experiments, hazelnuts kernels were submitted to an extraction at 40° C. and different pressures. One batch was run by the process according to the present invention at a pressure of 1500 bar and, in a comparative experiment, the same amount of nut kernels were submitted to extraction by a process according to the state of the art at a pressure of 500 bar. The process according to the present invention yielded more than double the amount of oil and alkaloids with the same amount of CO₂, the portions of oil and alkaloids increasing nearly in parallel. These experiments also show that the high-pressure extraction according to the present invention is a thermally very gentle process.

In further series of experiments, comparative experiments according to the corresponding conventional state of the art were carried out. At first 0.5 kg sweet pepper (capsicum annuum) was filled into an extractor and extracted for three hours at 1800 bar and 60° C. The ratio of solvent to feedstock was 40, referred to their mass. In a first separator which was operated at 1000 bar and 40° C. 15 g of a dark red, semi-solid product containing capsanthin, capsorubin, beta-carotene, beta-cryptoxanthin, lutein, violaxanthin and zeaxanthin could be separated, corresponding to a yield of 3%. In the subsequent separator which was operated at 1000 bar and 40° C. an emulsion of aromatic components and water was separated. The solid residue still contained carotenes and carotinoides. In the comparative experiment according to the invention the same amount of sweet pepper was extracted at the same pressure and the same temperature but with a ratio of solvent to feedstock of at first 13 and an extraction period of one hour only. In a first separator, a comparable product was separated. In the subsequent separator, which was operated under the same conditions as mentioned before, also an emulsion of aromatic components and water separated, this emulsion, however, was re-concentrated and returned to the high-pressure extractor. In a further extraction stage, carotenes and carotinoides were also extracted and the yield together with capsanthin, capsorubin, beta-carotene, beta-cryptoxanthin, lutein, violaxanthin and zeaxanthin amounted to a total of 8%, the oil yield to again 10%. The ratio of solvent to feedstock for both extraction stages together was 40, as above, referred to their mass.

In a further comparative experiment, 0.5 kg chilli pepper (capsicum frutescens) was filled into an extractor and extracted for two hours at 2300 bar and 60° C. The ratio of solvent to feedstock was 35, referred to their mass. In a first separator which was operated at 1000 bar and 40° C. 18 g of a dark red, semi-solid product containing capsanthin, capsorubin, beta-carotene, beta-cryptoxanthin, lutein, violaxanthin and zeaxanthin could be separated, corresponding to a yield of 3.6%. In the subsequent separator which was operated at 300 bar and 40° C. an emulsion of aromatic components and water was separated. The solid residue still contained carotenes and carotinoides. In the comparative experiment according to the invention the same amount of chilli pepper was extracted at the same pressure and the same temperature but with a ratio of solvent to feedstock of at first 17.5 and an extraction period of one hour only. In a first separator, a comparable product was separated. In the subsequent separator, which was operated under the same conditions as mentioned before, also an emulsion of aromatic components and water separated, this emulsion, however, was re-concentrated and returned to the high-pressure extractor. In a further extraction stage, carotenes and carotinoides were also extracted and the yield together with capsanthin, capsorubin, beta-carotene, beta-cryptoxanthin, lutein, violaxanthin and zeaxanthin amounted to a total of 7%, the oil yield to again 10%. The ratio of solvent to feedstock for both extraction stages together was 40, referred to their mass.

In a further comparative experiment, 0.5 kg tomato powder (lycoperscum esculentum) was filled into an extractor and extracted for two hours at 2800 bar and 60° C. The ratio of solvent to feedstock was 35, referred to their mass. In a first separator which was operated at 1000 bar and 40° C. 12 g of a dark red, semi-solid product containing carotenes and carotinoides, predominantly licopen and beta-carotene, could be separated, corresponding to a yield of 2.4%. In the subsequent separator which was operated at 300 bar and 40° C. an emulsion of aromatic components and water was separated. The solid residue still contained carotenes and carotinoides. In the comparative experiment according to the invention the same amount of tomato powder was extracted at the same pressure and the same temperature but with a ratio of solvent to feedstock of at first 17.5 and an extraction period of one hour only. In a first separator, a comparable product was separated. In the subsequent separator, which was operated under the same conditions as mentioned before, also an emulsion of aromatic components and water separated, this emulsion, however, was re-concentrated and returned to the high-pressure extractor. In a further extraction stage, further carotenes and carotinoides were extracted and the yield amounted to a total of 4%, the oil yield again to 10%. The ratio of solvent to feedstock for both extraction stages together was 40, referred to their mass.

1-10. (canceled)

11. An extraction process for the recovery of soluble substances from plant or animal organic raw materials under high pressure, in which at least one supercritical gas is used as a solvent, in which
one or more high-pressure vessels are filled with the organic material, sealed and then submitted to a pressure of more than 800 bar, subsequently
the supercritical gas is passed at least once through the filled high-pressure vessel in an extraction stage, without admixing any additional entrainer to the supercritical gas and subsequently
the laden supercritical gas is completely or partly supplied to a separating stage in which natural substances or substance mixtures are separated or separated of each other while decreasing the pressure,
wherein the pressure in the extraction stage exceeds the maximum solubility pressure of the raw-material-specific oil or fat in the supercritical gas by at least 10%, the respective raw-material-specific oil or fat acting as entrainer.

12. The process according to claim 11, wherein the supercritical gas and solvent comprise CO₂.

13. The process according to claim 11, wherein an operating pressure of 1100 bar to 5000 bar is selected in the extraction stage.

14. The process according to claim 13, wherein an operating pressure of 1300 bar to 2500 bar is selected in the extraction stage.

15. The process according to claim 11, wherein the supercritical gas is re-circulated several times through the organic material in the high-pressure vessel of the extraction stage.

16. The process according to claim 11, wherein the temperature of the supercritical gas is changed before or in the separating stage by means of a heat exchanger.

17. The process according to claim 12, wherein the pressure in the first separator which follows the extraction stage downstream is adjusted within the range of the maximum solubility of the raw-material-specific oil or fat in CO₂.

18. The process according to claim 11, wherein the pressure in the first separator ranges between 800 bar and 1000 bar.

19. The process according to claim 11, wherein at least two separators are provided in the separating stage.

20. The process according to claim 12, wherein a further extraction stage is added upstream of the extraction, in which the pressure is adjusted within the range of the maximum solubility of the raw-material-specific oil or fat in CO₂.

21. The process according to claim 17, wherein the pressure in the first separator is ±2% of the maximum.

22. The process according to claim 19, wherein 3 or 4 separators are provided in the separating stage.

23. The process according to claim 20, wherein the pressure in the further extraction stage is within ±2% of the maximum.
